(19) United States
(12) Patent Application Publication
(10) Pub. No.: US 2026/0162618 A1
(43) Pub. Date: Jun. 11, 2026

(54) DISPLAY DEVICE AND POWER MANAGEMENT INTEGRATED CIRCUIT

(71) Applicant: LG Display Co., Ltd., Seoul (KR)

(72) Inventors: Juno Hur, Paju-si (KR); InRae Park, Paju-si (KR)

(73) Assignee: LG Display Co., Ltd., Seoul (KR)

(21) Appl. No.: 19/307,470

(22) Filed: Aug. 22, 2025

(30) Foreign Application Priority Data
Dec. 9, 2024 (KR) 10-2024-0181512

(51) Int. Cl. G09G 3/3266

(52) U.S. Cl. CPC G09G 3/3266; G09G 2330/022; G09G 2330/023

(57) ABSTRACT

A display device includes a display panel including a plurality of subpixels, a gate driving circuit configured to supply a gate signal to the display panel, and a power management integrated circuit. The power management circuit includes a selection signal generating circuit configured to compare an input voltage with a first reference voltage and to output a selection signal, a first boost converter configured to convert the input voltage into a power voltage to be supplied to the display panel, a multiplexer configured to select a trigger signal based on the selection signal, and a second boost converter configured to convert the power voltage into a gate high voltage to be supplied to the gate driving circuit based on the selected trigger signal.

### CROSS REFERENCE TO RELATED APPLICATION

This application claims priority from Korean Patent Application No. 10-2024-0181512, filed on Dec. 9, 2024, which is hereby incorporated by reference for all purposes as if fully set forth herein.

### TECHNICAL FIELD

Embodiments of the present disclosure relate to a display device and a power management integrated circuit and, more specifically, to a display device and a power management integrated circuit capable of improving the discharge characteristics of a display panel in a power-off process.

### BACKGROUND

As information technology develops, there is a growing market for a display device, which is a connecting medium between users and information. Accordingly, the use of various display devices, such as an organic light emitting display (OLED), a quantum dot display (QDD), a liquid crystal displays (LCD), and a plasma display panel (PDP), is increasing.

Among display devices, the organic light emitting display utilizes self-luminous light emitting diodes, which provide fast response speeds and have advantages in contrast ratio, luminous efficiency, brightness, and viewing angle.

The display device may include light emitting diodes arranged in each of a plurality of subpixels disposed on a display panel, and may control the brightness of each subpixel by controlling a voltage flowing to the light emitting diodes to emit light, thereby displaying images.

The display device may supply a gate high voltage of a specific level to all gate lines to discharge the electric charge in the display panel when the power is turned off.

However, if the gate high voltage supplied to the gate lines of the display panel is lowered at the same time as the power is turned off, there is a problem in that the display abnormality occurs due to the charge remaining in the display panel.

### SUMMARY

Accordingly, the present disclosure relates to a display device and a power management integrated circuit that substantially obviate one or more of the problems due to limitations and disadvantages of the related art.

Embodiments of the present disclosure may provide a display device and a power management integrated circuit capable of improving the discharge characteristics of a display panel in a power-off process.

Embodiments of the present disclosure may provide a display device and a power management integrated circuit capable of improving the discharge characteristics of a display panel in a power-off process by selecting a trigger signal for generating a gate high voltage according to a power-on process or a power-off process.

Embodiments of the present disclosure may provide a display device and a power management integrated circuit capable of improving the discharge characteristics of a display panel by controlling the level of a gate high voltage for discharging the charges remaining in a display panel in a power-off process.

The objectives, features, advantages, and embodiments of the present disclosure are not limited to the examples mentioned in this specification, and additional objectives, features, advantages, and embodiments of the present desclosure not specifically mentioned can be clearly understood by those skilled in the art from the description below or may be learned by the practice of the present disclosure.

To achieve these and other advantages and in accordance with the purpose of the present disclosure, as embodied and broadly described, a display device includes a display panel including a plurality of subpixels; a gate driving circuit configured to supply a gate signal to the display panel; and a power management integrated circuit including a selection signal generating circuit configured to compare an input voltage with a first reference voltage and to output a selection signal, a first boost converter configured to convert the input voltage into a power voltage to be supplied to the display panel, a multiplexer configured to select a trigger signal based on the selection signal, and a second boost converter configured to convert the power voltage into a gate high voltage to be supplied to the gate driving circuit based on the selected trigger signal.

In another aspect of the present disclosure, a power management integrated circuit includes a selection signal generating circuit configured to compare an input voltage with a first reference voltage and to output a selection signal, a first boost converter configured to convert the input voltage into a power voltage to be supplied to a display panel of a display device, a multiplexer configured to select a trigger signal based on the selection signal, and a second boost converter configured to convert the power voltage into a gate high voltage to be supplied to a gate driving circuit of the display device based on the selected trigger signal.

According to various embodiments of the present disclosure, it is possible to provide a display device and a power management integrated circuit capable of improving the discharge characteristics of a display panel in a power-off process.

According to various embodiments of the present disclosure, it is possible to provide a display device and a power management integrated circuit capable of improving the discharge characteristics of a display panel in a power-off process by selecting a trigger signal for generating a gate high voltage according to a power-on process or a power-off process.

According to various embodiments of the present disclosure, it is possible to provide a display device and a power management integrated circuit capable of improving the discharge characteristics of a display panel by controlling the level of a gate high voltage for discharging charges of a display panel in a power-off process.

The effects of the embodiments of the present disclosure are not limited to the effects described in this specification, and additional effects not mentioned can be clearly understood by those skilled in the art from the following description or may be learned by the practice of the present disclosure.

### BRIEF DESCRIPTION OF THE DRAWINGS

The accompanying drawings, which are included to provide a further understanding of the present disclosure and are incorporated in and constitute a part of the disclosure, illustrate aspects of the disclosure and together with the description serve to explain principles of the present disclosure. It should be therefore understood that aspects, examples, and embodiments described herein are not limited to the illustrations of the accompanying drawings.

FIG. 1 schematically illustrates a display device according to example embodiments of the present disclosure.

FIG. 2 illustrates a circuit configuring a subpixel in a display device according to example embodiments of the present disclosure.

FIG. 3 is a block diagram illustrating a configuration of a gate driving circuit in a display device according to example embodiments of the present disclosure.

FIG. 4 conceptually illustrates a power-on process and a power-off process of a gate driving circuit in a display device according to example embodiments of the present disclosure.

FIG. 5 is a block diagram illustrating a power management integrated circuit portion that generates a gate high voltage in a display device according to example embodiments of the present disclosure.

FIG. 6 illustrates a circuit configuration of a first boost converter that converts an input voltage into a power voltage in a display device according to example embodiments of the present disclosure.

FIG. 7 illustrates an example circuit diagram of a first level detector included in a first boost converter in a display device according to example embodiments of the present disclosure.

FIG. 8 illustrates a circuit configuration of a second boost converter that converts a power voltage into a gate high voltage in a display device according to example embodiments of the present disclosure.

FIG. 9 illustrates an example circuit diagram of a second level detector included in a second boost converter in a display device according to example embodiments of the present disclosure.

FIG. 10 illustrates a signal waveform diagram of a power-on process and a power-off process in a display device according to example embodiments of the present disclosure.

FIG. 11 illustrates an example circuit configuration of a second boost converter for controlling a level of a gate high voltage in a power-off process in a display device according to example embodiments of the present disclosure.

FIG. 12 illustrates a signal waveform diagram of a gate high voltage controlled by a second boost converter including a feedback circuit in a power-off process in a display device according to example embodiments of the present disclosure.

### DETAILED DESCRIPTION

Hereinafter, example embodiments of the present disclosure will be described in detail with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure.

The same reference numerals and signs may be used to designate the same or like components even when they are shown in different drawings. Further, in the following description of example embodiments of the present disclosure, detailed descriptions of well-known functions and components incorporated herein may be omitted where such detailed descriptions may obscure the subject matter of the present disclosure.

Such terms as “including,” “having,” “containing,” “constituting,” “make up of,” and “formed of” used herein are generally intended to allow other components to be added unless the terms are used with a more limiting term like “only.” As used herein, singular forms are intended to include plural forms, and vice versa, unless the context clearly indicates otherwise.

Terms, such as “first,” “second,” “A,” “B,” “(A),” and “(B),” may be used herein to describe elements of the present invention. Each of these terms is not used to define essence, order, sequence, number of elements, etc., but is used merely to refer to the corresponding element separately from other elements.

Where the specification describes that a first element “is connected or coupled to” or “contacts or overlaps” a second element, it should be interpreted that, not only can the first element “be directly connected or coupled to” or “directly contact or overlap” the second element, but a third element can also be “interposed” between the first and second elements, or the first and second elements can “be connected or coupled to” “contact or overlap” each other via a fourth element. Here, the second element may be included in at least one of two or more elements that “are connected or coupled to” or “contact or overlap” each other.

Where time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless a more limiting term like “directly” or “immediately” is used together.

In addition, where any dimensions, relative sizes, etc., are mentioned, it should be considered that numerical values for an elements or features, or corresponding information (e.g., level, range, etc.) includes a tolerance or error range that may be caused by various factors (e.g., process factors, internal or external impact, noise, etc.) even when a relevant description is not specified. Further, the term “may” fully encompass all the meanings of the term “can.”

Hereinafter, various example embodiments of the present disclosure will be described in detail with reference to the accompanying drawings.

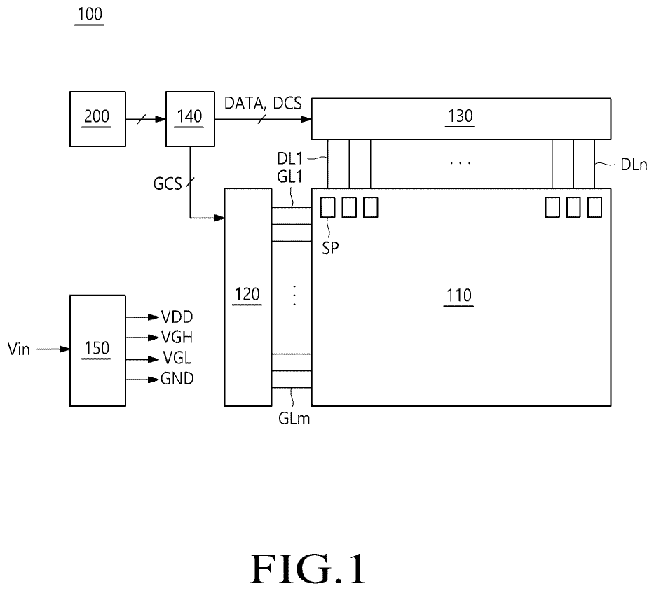

FIG. 1 schematically illustrates a display device according to example embodiments of the present disclosure.

As illustrated in FIG. 1, a display device 100 according to example embodiments of the present disclosure may include a timing controller 140, a gate driving circuit 120, a data driving circuit 130, a display panel 110, and a power management integrated circuit 150.

A host system 200 may supply a vertical synchronization signal, a horizontal synchronization signal, a data enable signal, a clock signal, and a data signal to the timing controller 140 through a low voltage differential signaling (LVDS) interface or a transition-minimized differential signaling (TMDS) interface.

The timing controller 140 may receive a data signal DATA from the host system 200, and may output a gate control signal GCS for controlling the operation timing of the gate driving circuit 120 and a data control signal DCS for controlling the operation timing of the data driving circuit 130.

The timing controller 140 may output a data signal DATA together with a gate control signal GCS and a data control signal DCS through an internal communication interface, such as an embedded clock point-to-point interface (EPI), and may control the operation timing of the gate driving circuit 120 and the data driving circuit 130.

The gate driving circuit 120 may output a gate signal while shifting a level of the gate voltage in response to the gate control signal GCS supplied from the timing controller 140. The gate driving circuit 120 may include a level shifter and a shift register.

The gate driving circuit 120 may supply a gate signal to a plurality of subpixels SP included in the display panel 110 through a plurality of gate lines GL1 to GLm. The gate driving circuit 120 may include a plurality of gate driving integrated circuits (GDIC) and may be formed in a gate-in-panel (GIP) manner in a non-display area of the display panel 110.

The data driving circuit 130 may sample and latch a data signal DATA in response to a data control signal DCS supplied from a timing controller 140, convert the digital data signal DATA into an analog data voltage in response to a gamma reference voltage, and output the converted data voltage.

The data driving circuit 130 may supply a data voltage to a plurality of subpixels SP included in the display panel 110 through a plurality of data lines DL1 to DLn. The data driving circuit 130 may include a plurality of source driving integrated circuits (SDIC).

The power management integrated circuit (PMIC) 150 may generate and output power, such as a power voltage VDD, a gate high voltage VGH, a gate low voltage VGL, and a ground voltage GND, based on an input voltage Vin. For example, the input voltage Vin may be 3.3 V, the power voltage VDD may be 8 V, the gate high voltage VGH may be 20 V, the gate low voltage VGL may be −20 V, and the ground voltage GND may be 0 V. The power voltage VDD may be a pixel driving voltage that drives a subpixel arranged on the display panel 110.

The voltage outputs from the power management integrated circuit 150 may be supplied separately to the timing controller 140, the gate driving circuit 120, the data driving circuit 130, and the display panel 110.

The power management integrated circuit 150 may change the gate signal supplied through all gate lines GL1 to GLm of the display panel 110 to a gate high voltage to discharge the remaining charge in the display panel 110 in a power-off process for cutting-off the power to the display device 100.

The display panel 110 may display an image in response to the gate signal supplied from the gate driving circuit 120 and the data voltage supplied from the data driving circuit 130. The display panel 110 may include a plurality of subpixels SP that are configured to emit light by themselves or control external light to display an image.

The display panel 110 may be configured as a liquid crystal display panel including a liquid crystal element or as an organic light-emitting display panel including an organic light emitting element.

If the display panel 110 is configured as a liquid crystal display panel, the display panel may operate in a TN (Twisted Nematic) mode, a VA (Vertical Alignment) mode, an IPS (In Plane Switching) mode, an FFS (Fringe Field Switching) mode, or an ECB (Electrically Controlled Birefringence) mode.

If the display panel 110 is configured as an organic light-emitting display panel, the display panel may operate in a top-emission mode, a bottom-emission mode, or a dual-emission mode.

As another example, the display device 100 according to example embodiments of the present disclosure may be a quantum dot display device implemented with a quantum dot, which is a semiconductor crystal that emits light by itself as a light emitting element.

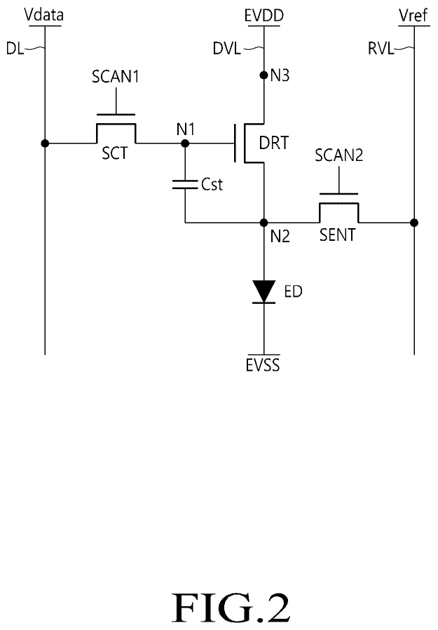

FIG. 2 illustrates a circuit configuring a subpixel in a display device according to example embodiments of the present disclosure.

As shown in FIG. 2, in a display device 100 according to example embodiments of the present disclosure, a subpixel SP may include one or more transistors and capacitors, and an organic light-emitting diode may be disposed as a light emitting element ED.

For example, a subpixel SP may include a driving transistor DRT, a switching transistor SWT, a sensing transistor SENT, a storage capacitor Cst, and a light emitting element ED.

The driving transistor DRT may have a first node N1, a second node N2, and a third node N3. The first node N1 of the driving transistor DRT may be a gate node to which a data voltage Vdata is applied from a data driving circuit 130 through a data line DL when the switching transistor SWT is turned on. The second node N2 of the driving transistor DRT may be electrically connected to an anode electrode of the light emitting element ED and may be one of a source node and a drain node. The third node N3 of the driving transistor DRT may be electrically connected to a driving voltage line DVL, to which a pixel high-potential voltage EVDD is applied, and may be the other of the drain node and the source node.

In this case, during a display driving period, the pixel high-potential voltage EVDD used to display an image may be supplied to the driving voltage line DVL. For example, the pixel high-potential voltage EVDD used to display an image may be 27 V.

The switching transistor SWT may be electrically connected between the first node N1 of the driving transistor DRT and the data line DL. The switching transistor SWT may have a gate node connected to a corresponding gate line GL and may operate according to a scan signal SCAN1 supplied through the corresponding gate line GL. In addition, if the switching transistor SWT is turned on, the data voltage Vdata supplied through the data line DL may be transferred to the gate node of the driving transistor DRT, thereby controlling the operation of the driving transistor DRT.

The sensing transistor SENT may be electrically connected between the second node N2 of the driving transistor DRT and a reference voltage line RVL. A corresponding gate line GL may be connected to the gate node of the sensing transistor SENT so that the sensing transistor SENT operates according to a sense signal SENSE (or SCAN2 in FIG. 2) supplied through the corresponding gate line GL. If the sensing transistor SENT is turned on, a first reference voltage Vref1 for sensing supplied through the reference voltage line RVL may be transferred to the second node N2 of the driving transistor DRT.

That is, by controlling the switching transistor SWT and the sensing transistor SENT, the voltages of the first node N1 and the second node N2 of the driving transistor DRT can be controlled, thereby enabling a current to be supplied to drive the light emitting element ED.

The gate nodes of the switching transistor SWT and the sensing transistor SENT may be connected together to one gate line GL, or may be connected to different gate lines GL. Here, a structure in which the switching transistor SWT and the sensing transistor SENT are connected to different gate lines GL is shown as an example. In this case, the switching transistor SWT and the sensing transistor SENT can be independently controlled by the scan signal SCAN1 and the sense signal SENSE (or SCAN2) transmitted respectively through two different gate lines GL.

Alternatively, if the switching transistor SWT and the sensing transistor SENT are connected to the same gate line GL, the switching transistor SWT and the sensing transistor SENT may be simultaneously controlled by a scan signal SCAN1 or a sense signal SENSE (or SCAN2) transmitted through one gate line GL, thereby increasing an aperture ratio of the subpixel SP.

In another aspect, the transistors arranged in the subpixel SP may be composed of not only n-type transistors but also p-type transistors, and an example where the transistors are composed of n-type transistors is shown here in FIG. 2.

A storage capacitor Cst may be electrically connected between the first node N1 and the second node N2 of the driving transistor DRT and may maintain the data voltage Vdata for one frame.

The storage capacitor Cst may also be connected between the first node N1 and the third node N3 of the driving transistor DRT, depending on the type of the driving transistor DRT. The anode electrode of the light emitting element ED may be electrically connected to the second node N2 of the driving transistor DRT, and a pixel low-potential voltage EVSS may be applied to a cathode electrode of the light emitting element ED.

Here, the pixel low-potential voltage EVSS may be a ground voltage or a voltage higher or lower than the ground voltage. In addition, the pixel low-potential voltage EVSS may vary depending on the driving state. For example, the pixel low-potential voltage EVSS at the display driving time and the pixel low-potential voltage EVSS at the sensing driving time may be set differently from each other. The pixel low-potential voltage EVSS may also be referred to as a base voltage.

The structure of the subpixel SP described above as an example is a 3T (Transistor) 1C (Capacitor) structure. This is only an example for explanation, and the subpixel SP may include one or more additional transistors, or in some cases, one or more additional capacitors. Alternatively, each of the plurality of subpixels SP may have the same structure, or some of the plurality of subpixels SP may have different structures.

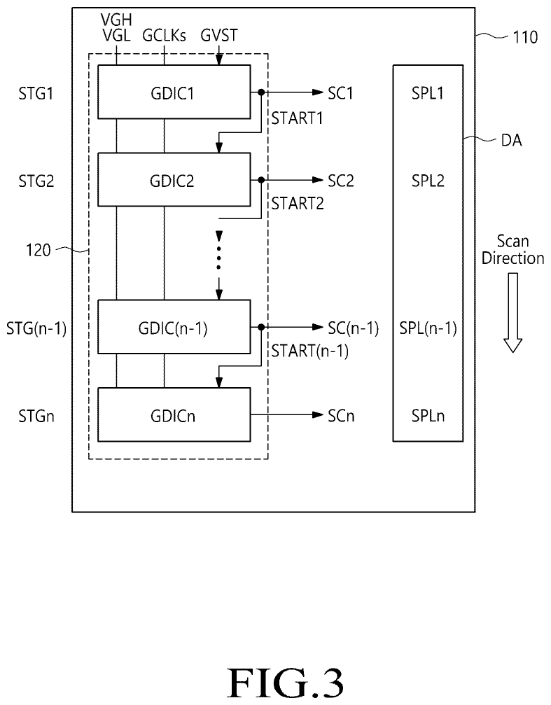

FIG. 3 is a block diagram illustrating an example of a configuration of a gate driving circuit in a display device according to example embodiments of the present disclosure.

As illustrated in FIG. 3, in the display device 100 according to example embodiments of the present disclosure, the gate driving circuit 120 may be disposed in the side bezel area of the display panel 110.

The gate driving circuit 120 may be composed of n stages STG1 to STGn in which n gate driving integrated circuits GDIC1 to GDICn are connected in a cascading manner. Here, n is a natural number greater than or equal to 2. The gate driving integrated circuits GDIC1 to GDICn may each be applied with a gate high voltage VGH and a gate low voltage VGL as driving voltages and may be operated by a gate clock signal GCLK.

A first gate driving integrated circuit GDIC1 may start operation in response to a gate start signal GVST, and a second gate driving integrated circuit GDIC2 to a n-th gate driving integrated circuit GDICn may receive scan signals SC1 to SC(n−1) output through an output terminal of the previous stage as start signals START1 to START(n−1), respectively. Here, the scan signals SC1 to SC(n−1) may be one type of gate signal.

For example, a first scan signal SC1 output from an output terminal of the first gate driving integrated circuit GDIC1 corresponding to the first stage STG1 may be applied to a first subpixel line SPL1 and to a start signal input terminal of the second gate driving integrated circuit GDIC2 of the second stage STG2.

Therefore, the first gate driving integrated circuit GDIC1 of the first stage STG1 uses the gate start signal GVST as a start signal, but in the second gate driving integrated circuit GDIC2 of the second stage STG2, the scan signal SC1 output from the output terminal of the gate driving integrated circuit GDIC1 located in the previous stage is used as the start signal START1.

Here, the first scan signal SC1 output from the output terminal of the first gate driving integrated circuit GDIC1 may be referred to as the first start signal START1 to indicate that the first scan signal SC1 generated in the first stage STG1 is used as the start signal of the next stage STG2.

The configuration of using the stage connected in this manner and using the scan signal of the previous stage as the start signal of the subsequent stage can be applied equally to all stages from STG1 to STGn, as can be seen from, for example, the relationship between the (n−1)-th stage STG(n−1) and the n-th stage STGn.

In another aspect, although an example where one scan signal is output from one stage (e.g., one gate driving integrated circuit GDIC) is illustrated here, two scan signals or four scan signals may be output from one stage (e.g., one gate driving integrated circuit GDIC) depending on the configuration of the gate driving integrated circuit.

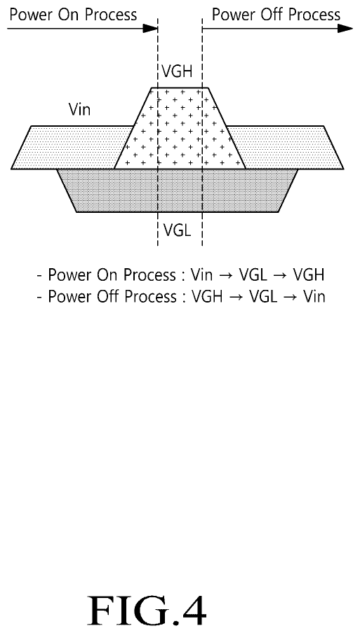

FIG. 4 is a diagram conceptually illustrating the power-on process and the power-off process of the gate driving circuit in the display device according to example embodiments of the present disclosure.

As illustrated in FIG. 4, the gate driving circuit 120 of the display device 100 according to example embodiments of the present disclosure may be equipped with a plurality of gate driving integrated circuits in the non-display area on both sides of the display panel 110.

The power management integrated circuit 150 may supply a gate high voltage VGH indicating a high logic of a gate signal and a gate low voltage VGL indicating a low logic of a gate signal to the gate driving integrated circuits.

In the case of a power-on process in which power is applied to the display device 100, the power management integrated circuit 150 may first supply a gate low voltage VGL and then supply a gate high voltage VGH based on the time point at which the input voltage Vin is applied. That is, a signal may be triggered in the order of input voltage Vin→gate low voltage VGL→gate high voltage VGH.

On the other hand, in the case of a power-off process in which power is cut off to the display device 100, the power management integrated circuit 150 may cut off the gate high voltage VGH from the point in time when the input voltage Vin reaches a level of a predetermined reference voltage, then cut off the output of the gate low voltage VGL, and then cut off the input voltage Vin. That is, the signal may be triggered in the order of gate high voltage VGH→gate low voltage VGL→input voltage Vin.

In the power-off process, the power management integrated circuit 150 may supply the gate high voltage VGH to all gate lines GL to discharge the remaining charge charged in the display panel 110.

However, if the gate high voltage VGH is lowered at the time when the input voltage Vin reaches a predetermined low potential level during this process, the remaining charge of the display panel 110 may not be sufficiently discharged, which may cause a screen abnormality.

The display device 100 according to embodiments of the present disclosure may improve the discharge characteristics of the display panel 110 in the power-off process by selecting a trigger voltage for maintaining the gate high voltage VGH depending on the power-on process or the power-off process.

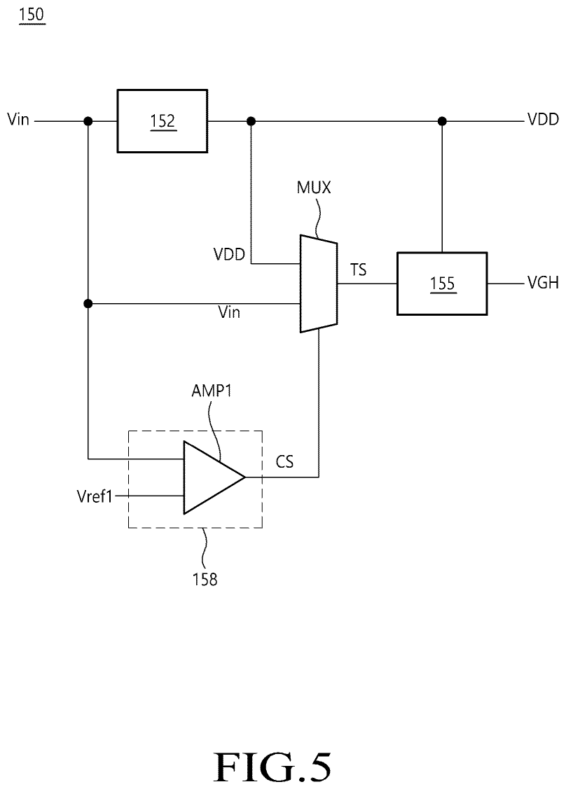

FIG. 5 illustrates a power management integrated circuit portion that generates a gate high voltage in a display device according to example embodiments of the present disclosure.

As shown in FIG. 5, the power management integrated circuit 150 of the display device 100 according to example embodiments of the present disclosure may include a first boost converter 152, a multiplexer MUX, a second boost converter 155, and a selection signal generating circuit 158.

The first boost converter 152 may convert an input voltage Vin into a power voltage VDD used for the display panel 110. If the input voltage Vin is 3.3 V and the power voltage VDD is 8 V, the first boost converter 152 may be a boost converter that boosts the voltage level.

The multiplexer MUX may receive the input voltage Vin and the power voltage VDD, and select a trigger signal TS from among the input voltage Vin and the power voltage VDD by a selection signal CS.

The second boost converter 155 may convert the trigger signal TS transmitted from the multiplexer MUX into a gate high voltage VGH used for the gate driving circuit 120. Since the trigger signal TS may be an input voltage Vin or a power voltage VDD, if the gate high voltage VGH is 17 V, the second boost converter 155 may be a boost converter that boosts the level of the voltage.

The selection signal generating circuit 158 may include a first amplifier AMP1 that compares the input voltage Vin with a first reference voltage Vref1 and may generate a high-level selection signal CS if the input voltage Vin is greater than the first reference voltage Vref1 by comparing the input voltage Vin with the first reference voltage Vref1.

The display device 100 according to example embodiments of the present disclosure may increase a duration of the gate high voltage VGH in the power-off process and improve the discharge effect of the display panel 110 by selecting the input voltage Vin as the trigger signal TS in the power-on process and selecting the power voltage VDD as the trigger signal TS in the power-off process.

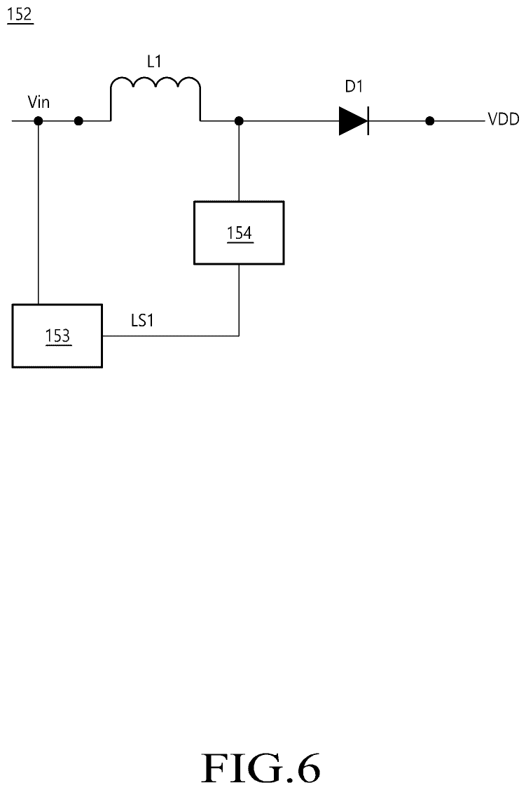

FIG. 6 illustrates an example of a circuit configuration of a first boost converter that converts an input voltage into a power voltage in a display device according to example embodiments of the present disclosure.

As illustrated in FIG. 6, in the display device 100 according to example embodiments of the present disclosure, the first boost converter 152 for generating the power voltage VDD using the input voltage Vin may include a first level detector 153, a first DC converter 154, a first inductor L1, and a first diode D1.

The first level detector 153 may monitor the input voltage Vin and generate a first level control signal LS1 for controlling the power voltage VDD if the input voltage Vin becomes higher or lower than the level of the first reference voltage Vref1.

For example, the first level detector 153 may block the generation of the power voltage VDD by stopping the operation of the first DC converter 154 through the first level control signal LS1 when the input voltage Vin becomes lower than an Under Voltage Lock-Out UVLO corresponding to a level of the first reference voltage Vref1 due to the power-off process of the display device 100.

The first inductor L1 may be connected between an input node to which the input voltage Vin is supplied and an anode terminal of the first diode D1.

The first diode D1 may be connected between the first inductor L1 and an output node outputting the power voltage VDD.

The first DC converter 154 may be a DC-DC converter that outputs the level of the power voltage VDD from the first level control signal LS1.

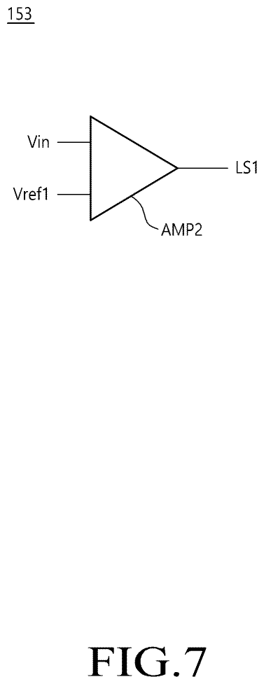

FIG. 7 illustrates an example circuit diagram of a first level detector included in a first boost converter in a display device according to example embodiments of the present disclosure.

As shown in FIG. 7, in the display device 100 according to example embodiments of the present disclosure, the first level detector 153 of the first boost converter 152 generating the power voltage VDD from the input voltage Vin may supply the first level control signal LS1 to the first DC converter 154 to block the power voltage VDD if the input voltage Vin is lowered to a level lower than the first reference voltage Vref1.

The first level detector 153 may include a second amplifier AMP2 that receives the input voltage Vin at a non-inverting terminal and receives the first reference voltage Vref1 at an inverting terminal.

Accordingly, the first level detector 153 may compare the input voltage Vin with the first reference voltage Vref1 and supply the first level control signal LS1 to the first DC converter 154 if the input voltage Vin is lowered to a level lower than the first reference voltage Vref1.

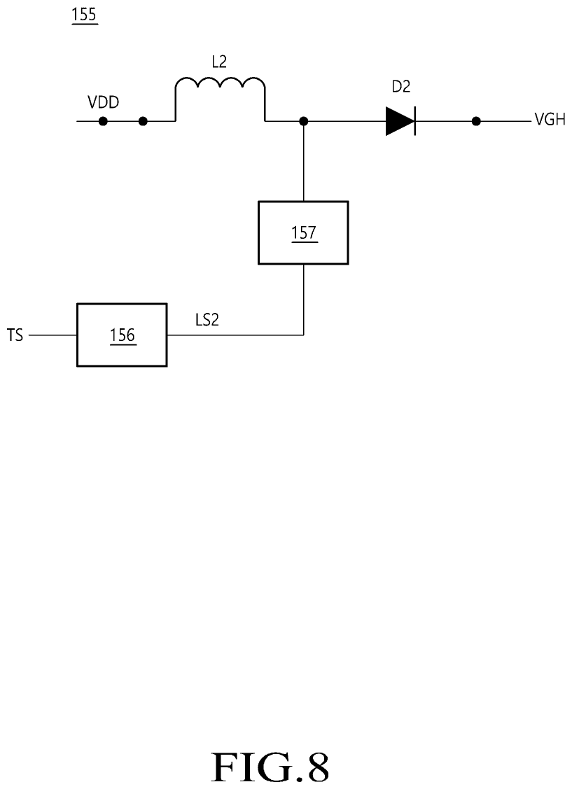

FIG. 8 illustrates a circuit configuration of a second boost converter that converts a power voltage VDD into a gate high voltage VGH in a display device according to example embodiments of the present disclosure.

As illustrated in FIG. 8, in a display device 100 according to example embodiments of the present disclosure, a second boost converter 155 for generating a gate high voltage VGH using a power voltage VDD may include a second level detector 156, a second DC converter 157, a second inductor L2, and a second diode D2.

The second level detector 156 may monitor a trigger signal TS and generate a second level control signal LS2 to block the gate high voltage VGH if the trigger signal TS becomes lower than an Under Voltage Lock-Out UVLO corresponding to a level of a first reference voltage Vref1.

The trigger signal TS may be an input voltage Vin or a power voltage VDD selected by a multiplexer MUX by a selection signal CS. In the case of a power-on process in which power is supplied to the display device 100, the input voltage Vin may be selected as the trigger signal TS. In addition, in the case of a power-off process in which power is cut off from the display device 100, the power voltage VDD may be selected as the trigger signal TS.

If the trigger signal TS is lowered to a level lower than the first reference voltage Vref1 by the power-off process in which power is cut off from the display device 100, the second level detector 156 may output a second level control signal LS2 to stop the operation of the second DC converter 157, thereby blocking the gate high voltage VGH.

The second inductor L2 may be connected between an input node supplied with a power voltage VDD and an anode terminal of the second diode D2.

The second diode D2 may be connected between the second inductor L2 and an output node outputting a gate high voltage VGH.

The second DC converter 157 may be a DC-DC converter that converts a second level control signal LS2 into a level of a gate high voltage VGH.

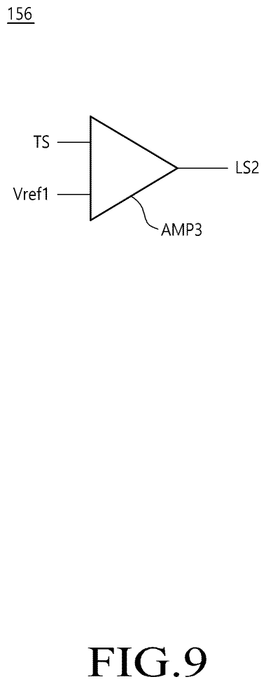

FIG. 9 illustrates an example circuit diagram of a second level detector included in a second boost converter in a display device according to example embodiments of the present disclosure.

As shown in FIG. 9, in the display device 100 according to example embodiments of the present disclosure, the second level detector 156 of the second boost converter 155 for generating the gate high voltage VGH from the power voltage VDD may supply the second level control signal LS1 to the second DC converter 157 to block the gate high voltage VGH if the trigger signal TS is lowered to a level lower than the first reference voltage Vref1.

The second level detector 156 may include a third amplifier AMP3 that receives the trigger signal TS at a non-inverting terminal and receives the first reference voltage Vref1 at an inverting terminal. The trigger signal TS may be selected as an input voltage Vin in the case of a power-on process and as a power voltage VDD in the case of a power-off process.

Accordingly, the second level detector 156 may compare the trigger signal TS with the first reference voltage Vref1 and supply the second level control signal LS2 to the second DC converter 157 if the trigger signal TS is lowered to a level lower than the first reference voltage Vref1.

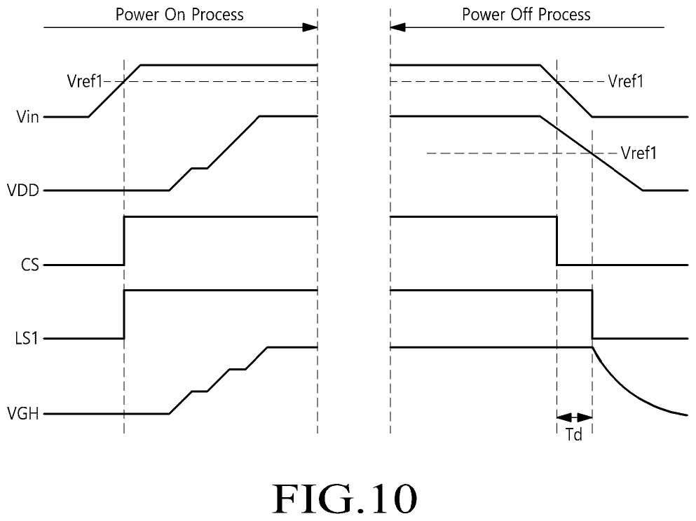

FIG. 10 illustrates signal waveforms of a power-on process and a power-off process in a display device according to example embodiments of the present disclosure.

As illustrated in FIG. 10, the display device 100 according to example embodiments of the present disclosure may improve the discharge characteristics of the display panel 110 by maintaining the gate high voltage VGH at a high level longer in the power-off process by differently selecting the trigger signal TS of the power-on process and the trigger signal TS of the power-off process.

Specifically, the display device 100 according to example embodiments of the present disclosure may generate the power voltage VDD and the gate high voltage VGH by using the input voltage Vin supplied from the host system as the trigger signal TS in the power-on process.

On the other hand, the power voltage VDD may be used as the trigger signal TS in the power-off process. In this case, since the power voltage VDD is a voltage that is a boosted input voltage Vin, if the power voltage VDD is used as the trigger signal TS, the lowering of the gate high voltage VGH may be delayed by the delay time Td compared to a case in which the input voltage Vin is used as the trigger signal TS.

Therefore, the display device 100 according to example embodiments of the present disclosure may improve the discharge characteristics of the display panel 110 since the high-level gate high voltage VGH applied to the gate driving circuit 120 in the power-off process is maintained longer by the delay time Td.

In addition, the display device 100 according to example embodiments of the present disclosure can further improve the discharge characteristics of the display panel 110 by increasing the level of the gate high voltage VGH in the power-off process.

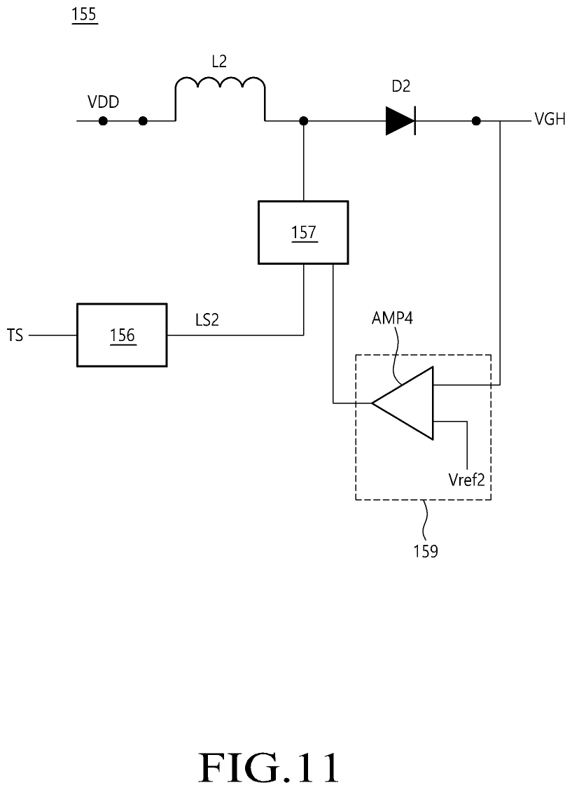

FIG. 11 illustrates another example of a circuit configuration of a second boost converter 155 that controls the level of the gate high voltage VGH in the power-off process in a display device according to example embodiments of the present disclosure.

As illustrated in FIG. 11, in the display device 100 according to example embodiments of the present disclosure, the second boost converter 155 for generating the gate high voltage VGH using the power voltage VDD may include a second level detector 156, a second DC converter 157, a second inductor L2, a second diode D2, and a feedback circuit 159.

In the power-off process, the second level detector 156 may receive the power voltage VDD as a trigger signal TS. Therefore, the second level detector 156 may generate a second level control signal LS2 to block the gate high voltage VGH if the power voltage VDD decreases to a level lower than the first reference voltage Vref1.

The second level detector 156 may output the second level control signal LS2 by comparing the trigger signal TS with the first reference voltage Vref1.

The second boost converter 155 may further include a feedback circuit 159 that generates an output signal by comparing the gate high voltage VGH with a second reference voltage Vref2.

The feedback circuit 159 may include a fourth amplifier AMP4 that compares the gate high voltage VGH and the second reference voltage Vref2. The feedback circuit 159 may supply a signal corresponding to the difference between the gate high voltage VGH and the second reference voltage Vref2 to the second DC converter 157.

The level of the second reference voltage Vref2 may increase from a time point when the input voltage Vin decreases below the first reference voltage Vref1 in the power-off process. In this case, the feedback circuit 159 may generate an output signal corresponding to the difference between the gate high voltage VGH and the second reference voltage Vref2, thereby increasing the gate high voltage VGH by the second DC converter 157.

The second inductor L2 may be connected between an input node supplied with the power voltage VDD and an anode terminal of the second diode D2.

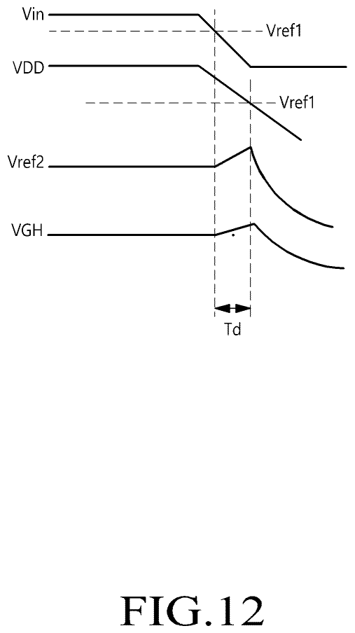

FIG. 12 illustrates a signal waveform of a gate high voltage VGH controlled by a second boost converter including a feedback circuit in a power-off process in a display device according to example embodiments of the present disclosure.

As shown in FIG. 12, the display device 100 according to example embodiments of the present disclosure may improve the discharge characteristics of the display panel 110 by maintaining the gate high voltage VGH at a high level longer in the power-off process by selecting the power voltage VDD as a trigger signal TS in the power-off process.

In this case, since the power voltage VDD is a voltage that is a boosted input voltage Vin, if the power voltage VDD is used as the trigger signal TS, a decrease in the gate high voltage VGH is delayed by a specific delay time Td compared to a case in which the input voltage Vin is used as the trigger signal TS.

In addition, the second boost converter 155 may further include a feedback circuit 159 composed of a fourth amplifier AMP4 that compares the gate high voltage VGH and the second reference voltage Vref2.

In this case, the second reference voltage Vref2 may increase from a time when the input voltage Vin falls below the first reference voltage Vref1. Therefore, the feedback circuit 159 may increase the level of the gate high voltage VGH by the second DC converter 157 through an output signal corresponding to the difference between the gate high voltage VGH and the second reference voltage Vref2.

As a result, the display device 100 according to example embodiments of the present disclosure may further improve the discharge characteristics of the display panel 110 by increasing the level of the gate high voltage VGH in the power-off process.

A display device according to various example embodiments of the present disclosure may be described as follows.

A display device according to example embodiments of the present disclosure may include a display panel including a plurality of subpixels, a gate driving circuit configured to supply a gate signal to the display panel, and a power management integrated circuit. The power management integrated circuit may include a selection signal generating circuit configured to compare an input voltage with a first reference voltage and to output a selection signal, a first boost converter configured to convert the input voltage into a power voltage to be supplied to the display panel, a multiplexer configured to select a trigger signal based on the selection signal, and a second boost converter configured to convert the power voltage into a gate high voltage to be supplied to the gate driving circuit based on the selected trigger signal.

The multiplexer may be further configured to select the trigger signal based on the selection signal in a power-on process and a power-off process of the display device. During the power-off process, the power management integrated circuit may be configured to begin decreasing the gate high voltage when the power voltage falls below the first reference voltage.

The first boost converter may include a first level detector configured to detect a level of the input voltage and to generate a first level control signal, a first diode connected to an output node of the first boost converter from which the power voltage is output, a first DC converter configured to convert the first level control signal into the power voltage to supply to an anode terminal of the first diode, and a first inductor connected between the anode terminal of the first diode and an input node of the first boost converter to which the input voltage is supplied.

The first level detector may include a first amplifier configured to compare the input voltage with the first reference voltage to generate the first level control signal.

The second boost converter may include a second level detector configured to detect a level of the trigger signal and to generate a second level control signal, a second diode connected to an output node of the second boost converter from which the gate high voltage is output, a second DC converter configured to convert the second level control signal into the gate high voltage to supply to an anode terminal of the second diode, and a second inductor connected between the anode terminal of the second diode and an input node of the second boost converter to which the power voltage is supplied.

The second level detector may include a second amplifier configured to compare the trigger signal with the first reference voltage to generate the second level control signal.

The second boost converter may further include a feedback circuit configured to compare the gate high voltage with a second reference voltage to supply an output signal to the second DC converter.

The second reference voltage may increase from a time when the input voltage falls below the first reference voltage.

The gate high voltage may increase as the second reference voltage increases.

The power voltage may have a level higher than the input voltage, and the gate high voltage may have a level higher than the power voltage.

The multiplexer may select the input voltage as the trigger signal in a power-on process of the display device, and may select the power voltage as the trigger signal in a power-off process of the display device.

A power management integrated circuit according to example embodiments of the present disclosure may include a selection signal generating circuit configured to compare an input voltage with a first reference voltage and to output a selection signal, a first boost converter configured to convert the input voltage into a power voltage to be supplied to a display panel of a display device, a multiplexer configured to select a trigger signal based on the selection signal, and a second boost converter configured to convert the power voltage into a gate high voltage to be supplied to a gate driving circuit of the display device based on the selected trigger signal.

The multiplexer may be configured to select the trigger signal based on the selection signal in a power-on process and a power-off process of the display device. During the power-off process, from a time when the input voltage falls below the first reference voltage to a time when the power voltage falls below the first reference voltage, the gate high voltage may be configured to remain constant or increase.

The above description has been presented to enable any person skilled in the art to make and use the technical ideas and features of the present disclosure, and has been provided in the context of a particular application and its requirements. Various modifications, additions, and substitutions to the described example embodiments will be readily apparent to those skilled in the art, and the general principles defined herein may be applied to other embodiments and applications without departing from the spirit and scope of the present disclosure. The above description and the accompanying drawings provide examples of the technical ideas and features of the present disclosure for illustrative purposes only. That is, the disclosed embodiments are intended to illustrate the scope of the technical ideas and features of the present disclosure by way of example without limiting the scope.

What is claimed is:

1. A display device, comprising:
a display panel including a plurality of subpixels;
a gate driving circuit configured to supply a gate signal to the display panel; and
a power management integrated circuit including:
a selection signal generating circuit configured to compare an input voltage with a first reference voltage and to output a selection signal;
a first boost converter configured to convert the input voltage into a power voltage to be supplied to the display panel;
a multiplexer configured to select a trigger signal based on the selection signal; and
a second boost converter configured to convert the power voltage into a gate high voltage to be supplied to the gate driving circuit based on the selected trigger signal.

2. The display device of claim 1, wherein:
the multiplexer is further configured to select the trigger signal based on the selection signal in a power-on process and a power-off process of the display device; and
during the power-off process, the power management integrated circuit is configured to begin decreasing the gate high voltage when the power voltage falls below the first reference voltage.

3. The display device of claim 1, wherein the first boost converter includes:
a first level detector configured to detect a level of the input voltage and to generate a first level control signal;
a first diode connected to an output node of the first boost converter from which the power voltage is output;
a first DC converter configured to convert the first level control signal into the power voltage to supply to an anode terminal of the first diode; and
a first inductor connected between the anode terminal of the first diode and an input node of the first boost converter to which the input voltage is supplied.

4. The display device of claim 3, wherein the first level detector includes a first amplifier configured to compare the input voltage with the first reference voltage to generate the first level control signal.

5. The display device of claim 1, wherein the second boost converter includes:
a second level detector configured to detect a level of the trigger signal and to generate a second level control signal;
a second diode connected to an output node of the second boost converter from which the gate high voltage is output;
a second DC converter configured to convert the second level control signal into the gate high voltage to supply to an anode terminal of the second diode; and
a second inductor connected between the anode terminal of the second diode and an input node of the second boost converter to which the power voltage is supplied.

6. The display device of claim 5, wherein the second level detector includes a second amplifier configured to compare the trigger signal with the first reference voltage to generate the second level control signal.

7. The display device of claim 5, wherein the second boost converter further includes a feedback circuit configured to compare the gate high voltage with a second reference voltage to supply an output signal to the second DC converter.

8. The display device of claim 7, wherein:
the second reference voltage increases from a time when the input voltage falls below the first reference voltage; and
the gate high voltage increases as the second reference voltage increases.

9. The display device of claim 1, wherein the power voltage has a higher level than the input voltage, and the gate high voltage has a higher level than the power voltage.

10. The display device of claim 1, wherein the multiplexer is configured to select the input voltage as the trigger signal in a power-on process of the display device and to select the power voltage as the trigger signal in a power-off process of the display device.

11. A power management integrated circuit, comprising:
a selection signal generating circuit configured to compare an input voltage with a first reference voltage and to output a selection signal;
a first boost converter configured to convert the input voltage into a power voltage to be supplied to a display panel of a display device;
a multiplexer configured to select a trigger signal based on the selection signal; and
a second boost converter configured to convert the power voltage into a gate high voltage to be supplied to a gate driving circuit of the display device based on the selected trigger signal.
